(19) United States
(12) Patent Application Publication
(10) Pub. No.: US 2017/0101022 A1
(43) Pub. Date: Apr. 13, 2017

(54) APPARATUS AND METHOD FOR DUAL AUTOMOBILE ELECTRIC CHARGER

(71) Applicant: Edward Morgan, Fort Worth, TX (US)

(72) Inventor: Edward Morgan, Fort Worth, TX (US)

(73) Assignee: REVITALIZE CHARGING SOLUTIONS, INC., Fort Worth, TX (US)

(21) Appl. No.: 14/881,048

(22) Filed: Oct. 12, 2015

(51) Int. Cl. B60L 11/18

(52) U.S. Cl. CPC B60L 11/1838; B60L 11/1816

(57) ABSTRACT

A multi-port charging unit is capable of charging at least two electric vehicles (EVs) utilizing a power supply configured to provide charging power to one EV. The multi-port charging unit includes a power cable configured to couple to a first EV. The multi-port charging unit also includes a power cable configured to couple to a first electric vehicle (EV) also includes an expansion port configured to couple via a removable conductor to a second EV. The multi-port charging unit also includes a switch configured to selectively couple a power source to the power cable and the expansion port. The multi-port charging unit further includes a processor configured to operate the switch to repeatedly alternate providing a charging power to the first EV and to the second EV

### TECHNICAL FIELD

This application relates to electric vehicles, and more specifically to a multi-port electric charger for the electric vehicles.

### BACKGROUND

Automobiles and passenger vans are omnipresent in modern society with almost every household owning or operating multiple vehicles. A vast majority of vehicles utilize a carbon-based fuel source such as gasoline, such as defined by: 2 C8H18+25 O2→16 CO2+18 H2O, which is combusted in internal piston chambers. The combustion of the gasoline produces energy by the conversion of a hydrocarbon to water and carbon dioxide. The carbon dioxide, which is output into the environment, is considered harmful to human and environmental health.

To offset a carbon footprint, which is the total sets of greenhouse gas emissions, including carbon dioxide, caused by an organization, event, product or individual, many individuals have chosen to operate an electric vehicle (EV). The EV, also referred to as an electric drive vehicle, uses one or more electric motors or traction motors for propulsion. With the exception of many public or rail driven electric vehicles that may be powered through a collector system by electricity from off-vehicle sources, most consumer EV's are powered by self-contained power source, such as a rechargeable battery.

### SUMMARY

In a first embodiment, an apparatus is provided. The apparatus includes a first power terminal configured to couple to a first electric vehicle (EV). The apparatus also includes a second power terminal configured to couple to a second EV. The apparatus further includes processing circuitry configured to selectively provide a charging power to the first EV and to the second EV by repeatedly alternately coupling a power source to the first power terminal and the second power terminal.

In a second embodiment, a multi-port charging unit is provided. The multi-port charging unit includes a power cable configured to couple to a first electric vehicle (EV). The multi-port charging unit also includes a power cable configured to couple to a first electric vehicle (EV) also includes an expansion port configured to couple via a removable conductor to a second EV. The multi-port charging unit also includes a switch configured to selectively couple a power source to the power cable and the expansion port. The multi-port charging unit further includes a processor configured to operate the switch to repeatedly alternate providing a charging power to the first EV and to the second EV.

In a third embodiment, a method is provided. The method includes detecting a coupling of a first electric vehicle (EV) to be electrically charged. The method also includes determining that a second EV is coupled to be electrically charged. The method further includes repeatedly alternating a charging power to the first EV and to the second EV when the second EV is coupled to be electrically charged.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases. Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example electric distribution and charging system according to this disclosure;

FIG. 2 illustrates a block diagram for a multi-port charging unit according to this disclosure;

FIG. 3 illustrates an example concurrent charging process by the multi-port charging unit according to this disclosure;

FIG. 4 illustrates a process for charging multiple vehicles according to this disclosure; and

FIGS. 5, 6, 7 and 8 illustrate example structures for a multi-port charging unit according to this disclosure.

### DETAILED DESCRIPTION

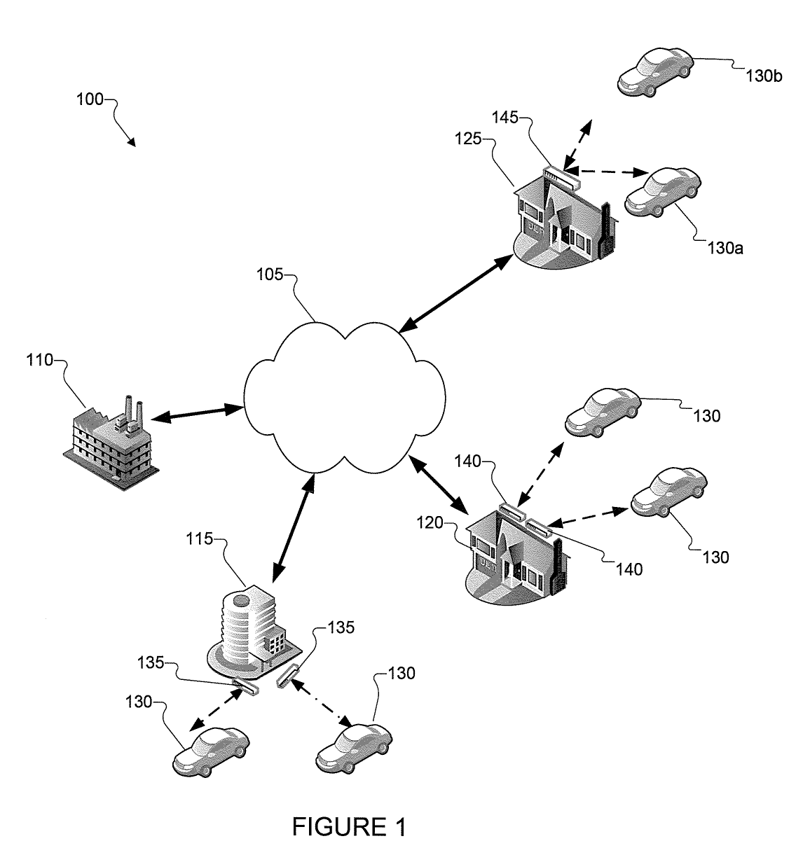

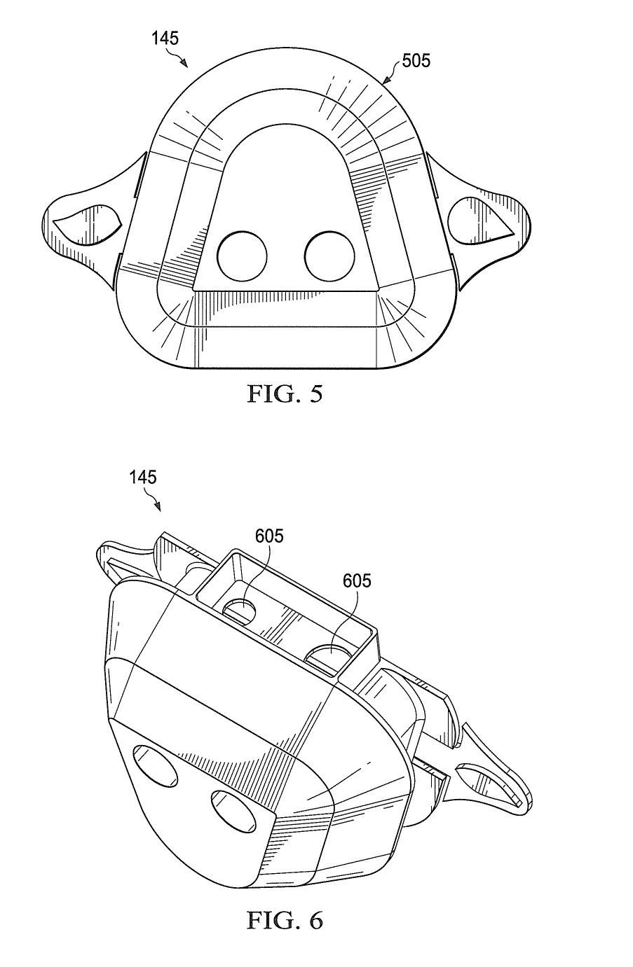

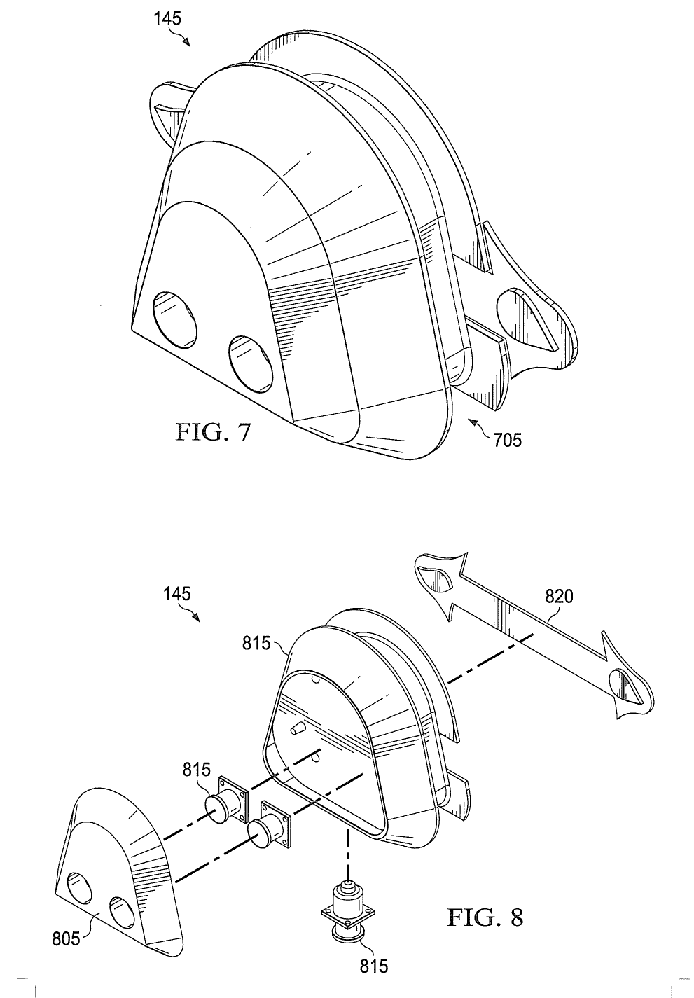

FIGS. 1 through 8, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

Herein, the term “electric vehicle” (EV) refers to any one of: an all-electric vehicle, a plug-in hybrid vehicle (PHEV), or a hybrid vehicle (HEV), or a low-emission vehicle (LEV) in which the HEV or LEV utilizes multiple propulsion sources, one of which is an electric drive system. An EV, or PHEV, HEV or LEV, stores electrical energy in an electrical energy storage system that has the capability to be charged and discharged, such as a battery, battery pack, capacitor or supercapacitor. The term “battery” may be used interchangeably with “battery system”, “cell” or “battery cell.” Batteries come in many varieties and embodiments of the present disclosure are not limited to any particular configuration or type of battery. For example, the battery may be any one or more of: lithium ion, such as lithium iron phosphate, lithium cobalt oxide, other lithium metal oxides, and the like, lithium ion polymer, nickel metal hydride, nickel cadmium, nickel hydrogen, nickel zinc, silver zinc, or any suitable configuration. In addition, the term “conductor” may be used interchangeably with “cable,” “cord,” “electrical conductor,” “electrical cable”, “electrical cord”, “power conductor,” “power cord”, “power cable” and so forth. A conductor is an insulated material configured to efficiently allow electricity to flow through it.

FIG. 1 illustrates an example electric distribution and charging system 100 according to this disclosure. The embodiment of the electric distribution and charging system 100 shown in FIG. 1 is for illustration only. Other embodiments of the electric distribution and charging system 100 could be used without departing from the scope of this disclosure.

The electric distribution and charging system 100 includes a distribution network 105, which facilitates distribution of electricity between various components in the system 100. The components and design of the distribution network 105 is well known to those of ordinary skill. As such, description of the distribution network 105 is not provided in detail here. For example, the distribution network includes one or more high voltage transmission lines that carry a transmission voltage, such as having voltages at or above 69 kilovolts (KV); one or more electrical substations having step-down or step-up transformers; one or more rural distribution lines that carry a distribution voltage, such as having voltages at or below 25 KV; one or more distribution transforms, such as configured to convert electricity from a distribution voltage to a residential voltage, such as 120/240 volts; one or more capacitors; one or more regulators; one or more inductors; and a plurality of structures such as poles, vaults and conduits. In certain embodiments, the distribution network 105 includes one or more local area networks (LANs), metropolitan area networks (MANs), wide area networks (WANs), all or a portion of a global network such as the Internet, or any other communication system or systems at one or more locations.

The distribution network 105 facilitates electrical distribution between at least one power generator at an electrical power plant 110 and various electrical loads 115-125. One or more electrical generators at the electrical power plant 110 generate electricity and deliver the generated electricity to the distribution network 105, which distributes the electricity to various electrical loads such as factories, stores, stadiums, schools, businesses 115, and homes 120 and 125, and the like.

Each electrical load 115-125 represents any suitable electrical device that utilizes electricity to operate, store or further distribute. In this example, the electrical loads 115-125 include businesses 115, and homes 120 and homes 125. However, any other or additional electrical loads could be used in the electric distribution and charging system 100.

In this example, some businesses 115, and homes 120 and homes 125 further provide an electrical charging to one or more electric vehicles 130. That is, certain businesses 115, and homes 120 and homes 125 further distribute electricity to charge EVs 130. For example, the business 115 includes one or more public charging stations 135 to charge EVs 130. Each public charging station 135 is configured to charge a single EV 130. For example, each public charging station 135 includes a single charging cable adaptable to connect to a charging port of the EV 130 and provide a charging voltage of up to 240 volts direct current (DC).

Many individuals are able to charge their electrical vehicles at their home 120. In some homes 120, the EV 130 is charged via a power cord connected to a standard wall outlet at 110 volts Alternating Current (AC) or charged via a power cord connected to a 240 volt AC wall outlet. Certain homes 120 can include a charging unit 140 to charge EVs 130. Each charging unit 140 is configured to charge a single EV 130. For example, each charging unit 140 includes a single charging cable adaptable to connect to a charging port of the EV 130 and provide a charging voltage of up to 240 volts (V) direct current (DC) and 40 amperes (Amps). If, however, the individual owns two or more EVs 130, the individual must either plug-in, that is, charge, one vehicle at a time or install a second charging unit 140. However, installing a second charging unit 140 can be expensive in terms of cost to purchase the unit and cost to install the unit since an additional load requirement of 40 Amps at 240 volts is very large compared to a standard residential load.

As described in more detail below, some individuals are able to charge multiple electrical vehicles at their home 125. The home 125 includes a multi-port charging unit 145 that is configured to charge at least two EVs 130 concurrently. The multi-port charging unit 145 is configured to couple to at least two EVs 130. For example, the multi-port charging unit 145 includes a single charging cable adaptable to connect to a charging port of the EV 130 and an expansion port configured to couple to an additional charging cable adaptable to connect to a charging port of the EV 130. Although the example in FIG. 1 illustrates charging two EVs 130, embodiments in which more than two EVs are charged could be used without departing from the scope of the present disclosure. In certain embodiments, the multi-port charging unit 145 includes two or more charging cables adaptable to connect to a charging port of the EV 130, or one or more expansion ports configured to couple to an additional charging cable adaptable to connect to a charging port of the EV 130, or a combination thereof. In certain embodiments, the multi-port charging unit 145 provides a charging voltage of up to 240 volts (V) direct current (DC) and 40 amperes (Amps). In certain embodiments, the multi-port charging unit 145 provides a charging voltage of up to 240 volts (V) direct current (DC) and up to 80 amperes (Amps). The multi-port charging unit 145 is configured to regulate delivery of an electrical current at a specified charge to each connected electrical vehicle 130. The multi-port charging unit 145 manages delivery of the electrical charge to each electrical vehicle 130 to enable a concurrent electrical charging of each connected electrical vehicle 130.

Although FIG. 1 illustrates one example of an electric distribution and charging system 100, various changes may be made to FIG. 1. For example, the electric distribution and charging system 100 could include any number of each component in any suitable arrangement. In general, electrical systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

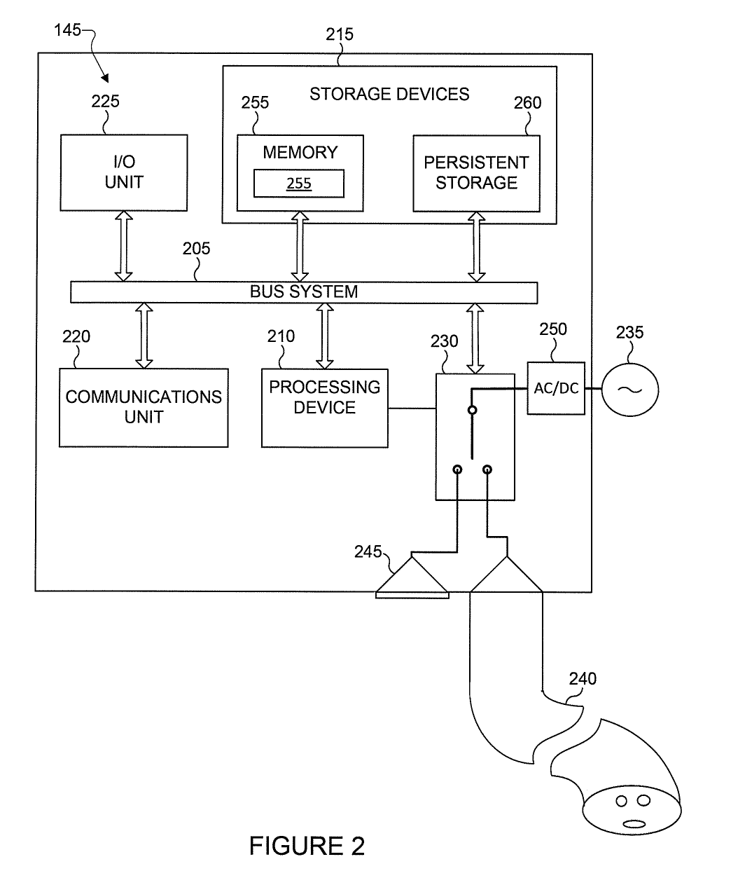

FIG. 2 illustrates a block diagram for a multi-port charging unit 145 according to this disclosure. The embodiment of the multi-port charging unit 145 is for illustration only. Other embodiments could be used without departing from the scope of the present disclosure.

In the example shown in FIG. 2, the multi-port charging unit 145 includes a bus system 205. The bus system 205 supports communication between at least one processing device 210, at least one storage device 215, at least one communications unit 220, at least one input/output (I/O) unit 225, and at least one power switch 230. The multi-port charging unit 145 couples a power source 235 to an EV 130 via either a charging cable 240 or charging port 245 through at least one AC to DC (AC/DC) converter 250.

The memory 255 and a persistent storage 260 are examples of storage devices 215, which represent any structure(s) capable of storing and facilitating retrieval of information (such as data, program code, and/or other suitable information on a temporary or permanent basis). The memory 255 may represent a random access memory or any other suitable volatile or non-volatile storage device(s). The persistent storage 260 may contain one or more components or devices supporting longer-term storage of data, such as a ready only memory, hard drive, Flash memory, or optical disc.

The communications unit 220 supports communications with other systems or devices, such as communications with one or more EVs 130, an external terminal, or a combination there. For example, the communications unit 220 could include a network interface card, universal serial bus, or a wireless transceiver facilitating communications over the network 102. The communications unit 220 can support communications through any suitable physical or wireless communication link(s). In certain embodiments, the communications unit 220 is configured to communicate with the electrical vehicle 130 through the power switch 230.

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

The power switch 230 operates under control of the processing device 210. The power switch 230 selectively couples a power source 235 to one or more power terminals which include the charging cable 240 or charging port 245. For example, power switch 230 selectively couples the power source 235 to one or more charging cables 240 or couples the power source 235 to one or more charging ports 245. The charging cable 240 is adapted to couple to a charging port of the EV 130. In certain embodiments, a AC/DC converter 250 converts the electrical energy from AC to DC prior to switching by power switch 230. In certain embodiments, the multi-port charging unit 145 includes multiple converters 250 disposed either between the power switch 230 and the power source 235 or between the power switch 230 and the one or more charging cables 240 and the one or more charging ports 245.

The charging port 245 enables an expansion capability to the multi-port charging unit 145 and can be referenced as an expansion port. The charging port 245 is adapted to couple to a removable conductor, or power cord thus enabling the multi-port charging unit 145 to be expanded to accommodate more vehicles additional vehicles are acquired.

The processing device 210 executes instructions that may be loaded into a memory 255. The processing device 210 can include any suitable number(s) and type(s) of processors or other devices in any suitable arrangement. Example types of processing devices 210 include microprocessors, microcontrollers, digital signal processors, field programmable gate arrays, application specific integrated circuits, discreet circuitry and ARM (Advanced RISC Machines) platforms. The processing device 210 can include one or more processors or other processing devices and execute a basic OS program 255 stored in the memory 255 in order to control the overall operation of the multi-port charging unit 145. For example, the processing device 210 could control the reception of forward channel signals and the transmission of reverse channel signals by the RF communications unit 220, I/O unit 225, and the power switch 230 in accordance with well-known principles. In some embodiments, the processing device 210 includes at least one microprocessor or microcontroller.

The processing device 210 is also capable of executing other processes and programs resident in the memory 255, such as operations for managing a concurrent electrical charging of two or more EVs 130 via one or more charging cables 240 or charging ports 245. The processing device 210 can move data into or out of the memory 255 as required by an executing process. In some embodiments, the processing device 210 is configured to execute the applications based on the OS program 255 or in response to signals received from coupled EVs 130, external devices or an operator. The processing device 210 is also coupled to the I/O interface 225, which provides the multi-port charging unit 145 with the ability to connect to other devices such as laptop computers and handheld computers. The I/O interface 225 is the communication path between these accessories and the processing device 210.

The processing device 210 controls an operation of the power switch 230. The processing device 210 operates the power switch 230 to selectively couple either a charging cable 240 to the power source 235 or couple a charging port 245 the power source 230. That is, the processing device 210 operates the power switch 230 to provide electrical energy to only one of the one or more charging cables 240 and the one or more charging ports 245 such that, at a given instant in time, the power switch 230 provides electrical energy only one of the charging cables 240 or the power switch 230 provides electrical energy only one of the charging ports 245. The processing device 210 controls the power switch 230 to direct electrical energy to one of the specified loads, namely the charging cable 240 or the charging port 245, for a predetermined charging time. The predetermined charging time is a period of time during which, electrical energy is provided to the EV 130. After the predetermined time has lapsed, the processing device 210 controls the power switch 230 to direct the electrical energy to another of the specified loads. For example, during a first charging interval, charging time T1, the processing device 210 controls the power switch 230 to direct electrical energy to the charging cable 240 removably coupled to a first EV 130; thus charging the first EV 130. During a second charging interval, charging time T2, the processing device 210 controls the power switch 230 to direct electrical energy to the charging port 245 coupled to a second EV 130 via a removable conductor; thus charging the second EV 130. During a third charging interval, charging time T3, the processing device 210 controls the power switch 230 to direct electrical energy to the charging cable 240; thus charging the first EV 130 and not providing electrical energy to the second EV 130. During a fourth charging interval, charging time T4, the processing device 210 controls the power switch 230 to direct electrical energy to the charging port 245; thus charging the second EV 130 and not providing electrical energy to the first EV 130. The processing device 210 continues to alternate a charging of the EVs 130 via the charging cable 240 and charging port 245 respectively until at least one of the first EV 130 or second EV 130 attains a set charge limit.

In certain embodiments, the processing device 210 is configured to communicate with the EV 130 via either the charging cable 240 or the charging port 245, respectively. For example, when the EV 130 is coupled to the multi-port charging unit 145 via the charging cable 240, the processing device 210 communicates with one or more processors, or processing circuitry, within the EV 130 through the charging cable 240. When the EV 130 is coupled to the multi-port charging unit 145 via the charging port 245 and a removable conductor, the processing device 210 communicates with one or more processors, or processing circuitry, within the EV 130 through the charging port 245 and removable conductor.

Although FIG. 2 illustrates examples of devices in an electrical delivery system, various changes may be made to FIG. 2. For example, various components in FIG. 2 could be combined, further subdivided, or omitted and additional components could be added according to particular needs. As a particular example, the processing device 210 could be divided into multiple processors, such as one or more central processing units (CPUs) and one or more graphics processing units (GPUs). In addition, as with computing and communication networks, electrically operated devices and electrical components can come in a wide variety of configurations, and FIG. 2 does not limit this disclosure to any particular electrical component or electrical device.

When an operator, homeowner or individual that owns or operates a first EV 130a, connects the first EV 130a to the multi-port charging unit 145, the processing device 210 communicates with one or more processing systems in the first EV 130a. The communication between the processing device 210 and the one or more processing systems in the first EV 130a can be initiated by the processing device 210 or be initiated by the one or more processing systems in the first EV 130a. The one or more processing systems in the first EV 130a can include a vehicle processor, a battery processor, or a combination of the above. The processing device 210 and one or more processing systems in the first EV 130a communicate charging information between each other. The charging information can include: a state of charge of an EV battery, charging requirements for the EV battery, charging parameters such as required voltage or required current, projected charge time, charge limit including percent charge desired for the EV battery, and charging capabilities of the multi-port charging unit 145 such as, delivery voltage and delivery current. Based on the charging information, the multi-port charging unit 145 and the first EV 130a establish a charging cycle for charging the EV battery. For example, the charging cycle can comprise a specified delivery voltage and delivery current to charge the EV battery. Periodically, the one or more processing systems in the first EV 130a can communicate a current charge level of the EV battery. In certain embodiments, the one or more processing systems in the first EV 130a communicate the current charge level of the EV battery. In response to receiving the current charge level, the processing device 210 and one or more processing systems in the first EV 130a adjust or maintain the charging cycle for charging the EV battery.

When a second the operator, homeowner or individual that owns or operates a second EV 130b, connects the second EV 130b to the multi-port charging unit 145, while the first EV 130a is connected to the multi-port charging unit 145 and being charged, the processing device 210 communicates with one or more processing systems in the second EV 130b. The second EV 130b can be coupled to the multi-port charging 145 unit via a removable conductor that is adapted to couple to the charging port 245. The communication between the processing device 210 and the one or more processing systems in the second EV 130b can be initiated by the processing device 210 or be initiated by the one or more processing systems in the second EV 130b. The one or more processing systems in the second EV 130b can include a vehicle processor, a battery processor, or a combination of the above. The processing device 210 and one or more processing systems in the second EV 130b communicate charging information between each other. The charging information can include: a state of charge of an EV battery, charging requirements for the EV battery, charging parameters such as required voltage or required current, projected charge time, charge limit including percent charge desired for the EV battery, and charging capabilities of the multi-port charging unit 145 such as, delivery voltage and delivery current. Based on the charging information for the second EV 130b and the charging information for the first EV 130a, the multi-port charging unit 145 and the second EV 130b establish a charging cycle for charging the EV battery for the second EV 130b and establish or revise a charging cycle for charging the EV battery of the first EV 130a. For example, the charging cycle can comprise a specified delivery voltage, delivery current, and delivery schedule including one or more charging start times, one or more charging stop times, or one or more charging durations, to charge the EV 130 battery. The one or more charging start times, one or more charging stop times, or one or more charging durations can be preset, operator adjustable or determined as a function a charging level of either or both of the EV batteries for the first EV 130a and the second EV 130b respectively. For example, the charging duration can be set to provide an electrical energy to the first EV 130a for ten seconds; then provide an electrical energy to the second EV 130b for ten seconds, then provide an electrical energy to the first EV 130a for ten seconds; then provide an electrical energy to the second EV 130b for ten seconds, and so forth. Periodically, the one or more processing systems in the second EV 130b can communicate a current charge level of the EV battery. In certain embodiments, the one or more processing systems in the second EV 130b communicate the current charge level of the EV battery. In response to receiving the current charge level, the processing device 210 and one or more processing systems in the second EV 130b adjust or maintain the charging cycle or charging cycle duration for charging the EV battery. Additionally, in response to receiving the current charge level from the first EV 130a or the second EV 130b, the processing device 210 adjusts or maintains the charging cycle or charging duration for charging the EV batteries.

When the multi-port charging unit 145 is coupled to two or more EV's 130 to charge each of the EVs 130, the multi-port charging unit 145 establishes multi-port charging for the two or more EVs 130 such that a concurrent and apparently simultaneous charging of the two or more EVs' 130 occurs. The processing device 210 negotiates a charging cycle with each of the two or more EVs 130. For example, each time certain EV's 130 connect to a charging unit, the EV 130 and the charging unit executes a series of communications and protocols prior to start the charging process and prior to a transfer of electrical energy into the battery. These communications and protocols can take several seconds to complete. In certain embodiments of the present disclosure, the processing device 210 negotiates with the EV 130 such that, after a commencement of a charging event and upon the termination of a first charging duration within the charging event, the series of communications and protocols are not required, not performed, or reduced prior to a commencement of a subsequent charging duration within a same charging event. Herein, a charging event refers to a time period commencing with a coupling of the EV 130 to the multi-port charging unit 145, delivering of electrical energy to the EV 130, and either terminating by a de-coupling of the EV 130 from the multi-port charging unit 145 or an attainment of a specified charge limit, whichever comes first. The processing device 210 enables a commencement of a subsequent charging duration without the need for several seconds to elapse before delivery of electrical energy to the battery. As such, the processing device 210 enables each charging duration to last only a few seconds if desired, such as a charging duration of approximately 10 seconds. By establishing a capability for each charging duration to last only a few seconds, the processing device 210 is able to alternately provide electrical energy for battery charging to the one or more EV's 130 coupled to the multi-port charging unit 145.

The processing device 210 in the multi-port charging unit 145 utilizes multiple non-overlapping charging durations to charge each EV 130 coupled to the multi-port charging unit 145. For example, the multi-port charging unit 145 can provide electrical energy to the first EV 130a during a first ten second time period while not providing electrical energy to the second EV 130b. During a second ten second time period, the multi-port charging unit 145 provides electrical energy to the second EV 130b while not providing electrical energy to the first EV 130a. During a third ten second time period, the multi-port charging unit 145 can provide electrical energy to the first EV 130a while not providing electrical energy to the second EV 130b. During a fourth ten second time period, the multi-port charging unit 145 provides electrical energy to the second EV 130b while not providing electrical energy to the first EV 130a. The multi-port charging unit 145 continues to alternately provide electrical energy to the first EV 130a and second EV 130b until at least one of the two EVs 130 attains a set charge limit, such as a charge limit of 90% charged. The example of a charge limit of 90% is for illustration only and charge limits that are higher, such as up to 100% or lower could be used without departing from the scope of the present disclosure. In certain embodiments, in response to one of the EVs 130 reaching the charge limit, the multi-port charging unit 145 continues to charge the other EV 130 until the other EV 130 attains the charge limit. Thereafter, the multi-port charging unit 145 maintains a state of charge for each EV 130 by periodically providing electrical energy to each vehicle respectively as a function of preset or negotiated parameters, or in response to communication request from the EV 130. In certain embodiments, in response to one of the EVs 130 reaching the charge limit, the multi-port charging unit 145 continues to alternately provide electrical energy to both EVs 130 to charge the other EV 130 until the other EV 130 attains the charge limit and to maintain a charge level of the EV 130 having already attained the charge limit.

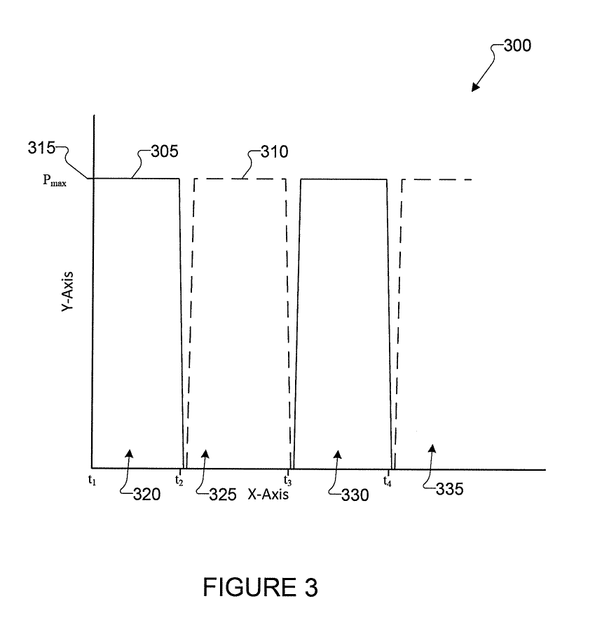

FIG. 3 illustrates an example concurrent charging process by the multi-port charging unit 145 according to this disclosure. The graphical representation of the concurrent charging process 300 shown in FIG. 3 is for illustration only. Other scenarios could be employed without departing from the scope of the present disclosure.

In the example graphical representation shown in FIG. 3, a first EV 130a and a second EV 130b are coupled to the multi-port charging unit 145 in order to charge their respective batteries. The first EV 130a may be coupled to the multi-port charging unit 145 either through a charging cable 240 or through a charging port 245 and removable conductor. The second EV 130b may be coupled to the multi-port charging unit 145 either through a charging cable 240 or through a charging port 245 and removable conductor. A first curve 305 illustrates a charging process for the first EV 130a and a second curve 310 illustrates a charging process for the second EV 130b. At time t₁, the first EV 130a is charging. It is assumed that, initially at time t₁, only the first EV 130a is coupled to the multi-port charging unit 145 provides. However, embodiments in which the second EV 130b is coupled firsts, or the first EV 130a and second EV 130b are coupled within seconds or minutes of each other equally apply. The multi-port charging unit 145 provides a power P. 315, which includes a specified voltage and a specified current. For example, the multi-port charging unit 145 can provide electrical energy at 240 volts and 40 Amps. During a first time period 320, from t₁ to t₂, also referenced as a charging duration, the multi-port charging unit 145 provides power Pₘₐₓ 315 to the first EV 130a. Additionally, although the first time period 320 is illustrated as being substantially equal to the other time periods, 325, 330 and 335, the first EV 130a may be coupled to the multi-port charging unit 145 for a longer or shorter period prior to a coupling of the second EV 130b such that the first time period 320 can be substantially longer or shorter than to the other time periods, 325, 330 and 335. Prior to time t₂, the second EV 130b couples to the multi-port charging unit 145. In response to the second EV 130b coupling to the multi-port charging unit 145, the multi-port charging unit 145 determines that at least two EVs are connected and require electrical energy to charge their respective batteries. The multi-port charging unit 145 establishes a charging schedule for the charging events for the respective EVs 130, such that a charging schedule is set for the first EV 130a and a charging schedule is set for the second EV 130b.

At time t₂, the multi-port charging unit 145 ceases providing charging power to the first EV 130a and commences to provide charging power to the second EV 130b. The processing device 210 causes the power switch 230 to electrically connect the second EV 130b to the power source 235. When the power switch 230 electrically connects the second EV 130b to the power source 235, the power switch 230 electrically disconnects the first EV 130a from the power source 235. As such, during a second time period 325 from t₂ to t₃, also referenced as a charging duration, the multi-port charging unit 145 provides power P. 315 to the second EV 130b. During the second time period 325, the first EV 130a does not receive charging power. In certain embodiments, the second time period 325 is a predetermined duration, such as 10 seconds. The illustration of a predetermined duration of 10 seconds is provided for illustration only and other values could be used without departing from the scope of the present disclosure. For example, in certain embodiments, the predetermined duration is greater than 10 seconds, such as a time value selected from a range of 10 seconds to 90 seconds. In certain embodiments, the processing device 210 calculates the duration for the second time period 325 as a function of the charging information provided by either or both of the EVs 130. In certain embodiments, the duration is set by the operator.

At time t₃, the multi-port charging unit 145 ceases providing charging power to the second EV 130b and commences to provide charging power to the first EV 130a. The processing device 210 causes the power switch 230 to electrically connect the first EV 130a to the power source 235. When the power switch 230 electrically connects the first EV 130a to the power source 235, the power switch 230 electrically disconnects the second EV 130b from the power source 235. As such, during a third time period 330 from t₃ to t₄, also referenced as a charging duration, the multi-port charging unit 145 provides power Pₘₐₓ 315 to the first EV 130a. During the third time period 330, the second EV 130b does not receive charging power. In certain embodiments, the duration of the third time period 330 is equal to the duration of the second time period 325, such as 10 seconds. In certain embodiments, the processing device 210 calculates the duration for the third time period 330 as a function of the charging information provided by either or both of the EVs 130. In certain embodiments, the duration is set by the operator.

At time t₄, the multi-port charging unit 145 ceases providing charging power to the first EV 130a and commences to provide charging power to the second EV 130b. The processing device 210 causes the power switch 230 to electrically connect the second EV 130b to the power source 235. When the power switch 230 electrically connects the second EV 130b to the power source 235, the power switch 230 electrically disconnects the first EV 130a from the power source 235. As such, during a fourth time period 335, also referenced as a charging duration, the multi-port charging unit 145 provides power P. 315 to the second EV 130b. During the fourth time period 335, the first EV 130a does not receive charging power. In certain embodiments, the duration of the fourth time period 335 is equal to the duration of the second time period 325, such as 10 seconds. In certain embodiments, the processing device 210 calculates the duration for the fourth time period 330 as a function of the charging information provided by either or both of the EVs 130. In certain embodiments, the duration is set by the operator.

The processing device 210 repeats alternately charging the EVs 130 by switching an electrical connection between the power source 235 and each of the EVs 130 until one or both EVs reaches a charge limit. In certain embodiments, in response to the first EV 130a reaching the charge limit, the multi-port charging unit 145 continues to charge the second EV 130b until the second EV 130b attains the charge limit. Thereafter, the multi-port charging unit 145 maintains a state of charge for each EV 130 by periodically providing electrical energy to each vehicle respectively as a function of preset or negotiated parameters, or in response to communication request from the EVs 130. In certain embodiments, in response to the first EVs 130a reaching the charge limit, the multi-port charging unit 145 continues to alternately provide electrical energy to both EVs 130 to charge the second EV 130b until the second EV 130b attains the charge limit and to maintain a charge level of the first EV 130a. Illustration of the first EV 130a attaining the charge limit first is for ease of explanation only and embodiments in which the second EV 130b attains the charge limit first equally apply.

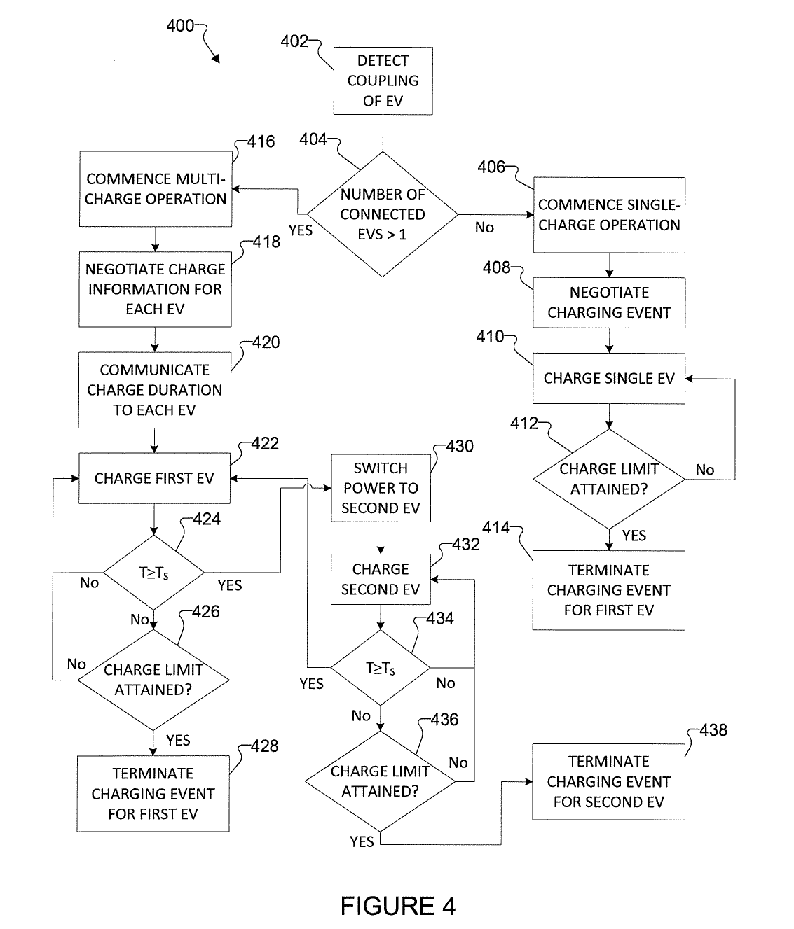

FIG. 4 illustrates a process for charging multiple vehicles according to this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a processing circuitry in, for example, an electrical charging unit.

In block 402, the multi-port charging unit 145 detects that an EV 130 has coupled to the multi-port charging unit 145. That is, the processing device 210 detects that an EV 130 has been electrically connected to the multi-port charging unit 145 through either the charging cable 240 or charging port 245. The processing device 210 can detect an attempt to draw current from the multi-port charging unit 145, the EV 130 may send a signal to the processing device 210, or the action of physically connecting a charge terminal on the EV 130 to the charging cable 240 or removable conductor connected to the charging port 245.

In block 404, the processing device 210 determines whether the number of connected EVs is one or greater than one. The processing device 210 uses the result of the determination to select whether to perform a continuous charging of a single EV or a concurrent charging of multiple EVs.

When the processing device 210 determines that only one EV 130 is coupled to the multi-port charging unit 145, the processing device 210 commences a single charge operation in block 406. The processing device 210 negotiates a charging event in block 408 by communicating with the EV 130 to obtain charge information. A charging event refers to a time period commencing with a coupling of the EV 130 to the multi-port charging unit 145, delivering of charging power to the EV 130, and either terminating by a de-coupling of the EV 130 from the multi-port charging unit 145 or an attainment of a specified charge limit. The processing device 210 can communicate with the EV 130 through the charging cable 240, or the removable conductor and charging port 245. The processing device 210 can send and receive signals to the one or more processors in the EV 130. The charging information can include: a state of charge of an EV battery, charging requirements for the EV battery, charging parameters such as required voltage or required current, projected charge time, charge limit including percent charge desired for the EV battery, and charging capabilities of the multi-port charging unit 145 such as, delivery voltage and delivery current. Based on the charging information, the processing device 210 and the one or more processors in the EV 130 establish a charging cycle for charging the EV battery.

After negotiating the charging event in block 408, a charging of the battery for the single EV is commenced in block 410. The processing device 210 proceeds to set, namely operate or configure, power switch 230 to electrically couple the EV 130 to the power source 235.

Periodically, the processing device 210 and the one or more processors in the EV 130 communicate during the charging event. In block 412, the processing device 210 determines whether the charge limit of the battery in the EV 130 has been attained. In certain embodiments, the one or more processors in the EV 130 determine whether the charge limit of the battery in the EV 130 has been attained and communicate this information to the processing device 210. When the charge limit has not been attained, the charging event continues in block 410. In certain embodiments, in response to the one or more processors in the EV 130 determining that the charge limit of the battery in the EV 130 has been attained, the one or more processors in the EV 130 send a charge termination signal to the processing device 210 to terminate the charging event in block 414. In certain embodiments, in response to the one or more processors in the EV 130 determining that the charge limit of the battery in the EV 130 has been attained, the one or more processors in the EV 130 terminate the charging event in block 414. In block 414, the processing device 210 proceeds to set, namely operate or configure, power switch 230 to electrically un-couple, such as disconnect, the EV 130 from the power source 235. For example, the processing device 210 can operate, or otherwise instruct, power switch 230 to switch to an open position.

When the processing device 210 determines that more than one EV 130 is coupled to the multi-port charging unit 145, the processing device 210 commences a multi-charge operation in block 416. The processing device 210 negotiates a charging event in block 418 by communicating with each of the EVs 130 to obtain respective charge information. A charging event refers to a time period commencing with a coupling of the EV 130 to the multi-port charging unit 145, delivering of charging power to the EV 130, and either terminating by a de-coupling of the EV 130 from the multi-port charging unit 145 or an attainment of a specified charge limit. The processing device 210 can communicate with each EV 130 through the respective charging cable 240, or the respective removable conductor and charging port 245. The processing device 210 can send and receive signals to the one or more processors in the respective EVs 130. The charging information can include: a state of charge of an EV battery, charging requirements for the EV battery, charging parameters such as required voltage or required current, projected charge time, charge limit including percent charge desired for the EV battery, and charging capabilities of the multi-port charging unit 145 such as, delivery voltage and delivery current. Based on the charging information, the processing device 210 and the one or more processors in the EV 130 establish a charging cycle for charging the EV battery.

In certain embodiments, in block 420, the processing device 210 communicates a charge duration to each EV 130. The processing device 210 sets the charging duration based on a specified charge duration time or in response to calculating a preferred charge duration time. In certain embodiments, block 420 is omitted and the multi-charge operation proceeds to block 422.

After negotiating the charging event in block 418, or after communicating the charge duration in block 420, a charging of the battery for the first EV 130a is commenced in block 422. The processing device 210 proceeds to set, namely operate or configure, power switch 230 to electrically couple the first EV 130a to the power source 235.

In block 424, the processing device 210 determines whether the charging duration has elapsed. For example, the processing device 210 can determine whether a charging time (T) has equaled or exceed the charge duration time (T_{S}). When T<Tₛ, the processing device 210 continues to charge the first EV 130a in block 422, which can be based on a charge limit determination in block 426. When T≧T_{S}, the processing device 210 proceeds to switch the charging operation to provide a charging power to the second EV 130b.

Periodically, the processing device 210 and the one or more processors in the EV 130 also communicate during the charging event. In block 426, the processing device 210 determines whether the charge limit of the battery in the first EV 130a has been attained. In certain embodiments, the one or more processors in the first EV 130a determine whether the charge limit of the battery in the first EV 130a has been attained and communicate this information to the processing device 210. When the charge limit has not been attained, the charging event for the first EV 130a continues in block 422. In certain embodiments, in response to the one or more processors in the first EV 130a determining that the charge limit of the battery in the first EV 130a has been attained, the one or more processors in the EV 130 send a charge termination signal to the processing device 210 to terminate the charging event in block 428. In certain embodiments, in response to the one or more processors in the first EV 130a determining that the charge limit of the battery in the EV 130 has been attained, the one or more processors in the first EV 130a terminate the charging event in block 428. In block 428, the processing device 210 proceeds to set, namely operate or configure, power switch 230 to electrically un-couple, such as disconnect, the first EV 130a from the power source 235. For example, the processing device 210 can operate, or otherwise instruct, power switch 230 to switch to an open position. In certain embodiments, in response to the charging event for the first EV 130a being terminated, the processing device 210 proceeds to charge the second EV 130b according to the single charge operation in block 406. In certain embodiments, in response to the charging event for the first EV 130a being terminated, the processing device 210 proceeds to charge the second EV 130b while periodically, such as at each charging duration interval or at a new charging duration interval, providing a continuing maintenance charging power to the first EV 130a.

In response to the processing device 210 determining that the charging duration has elapsed in block 424, the processing device switches the charging operation to provide charging power the second EV 130b in block 430. The processing device 210 proceeds to set, namely operate or configure, power switch 230 to electrically couple the second EV 130b to the power source 235. The processing device 210 operates, or instructs, the power switch 230 to electrically disconnect, or uncouple, the first EV 130a from the power source 235 and electrically couple the second EV 130b to the power source 235. A charging of the battery for the second EV 130b is commenced in block 432.

In block 434, the processing device 210 determines whether the charging duration has elapsed. For example, the processing device 210 can determine whether a charging time (T) has equaled or exceed the charge duration time (T_{S}). When T<Tₛ the processing device 210 continues to charge the second EV 130a in block 422, which can be based on a charge limit determination in block 436. When T≧T_{S}, the processing device 210 proceeds to switch the charging operation to provide a charging power to the first EV 130a. In response to the processing device 210 determining that the charging duration has elapsed in block 434, the processing device 210 operates, or instructs, the power switch 230 to electrically disconnect, or uncouple, the second EV 130b from the power source 235 and electrically couple the first EV 130a to the power source 235.

Periodically, the processing device 210 and the one or more processors in the second EV 130b also communicate during the charging event. In block 436, the processing device 210 determines whether the charge limit of the battery in the second EV 130b has been attained. In certain embodiments, the one or more processors in the second EV 130b determine whether the charge limit of the battery in the second EV 130b has been attained and communicate this information to the processing device 210. When the charge limit has not been attained, the charging event for the second EV 130b continues in block 432. In certain embodiments, in response to the one or more processors in the second EV 130b determining that the charge limit of the battery in the second EV 130b has been attained, the one or more processors in the second EV 130b send a charge termination signal to the processing device 210 to terminate the charging event in block 438. In certain embodiments, in response to the one or more processors in the first EV 130a determining that the charge limit of the battery in the second EV 130b has been attained, the one or more processors in the second EV 130b terminate the charging event in block 438. In block 438, the processing device 210 proceeds to set, namely operate or configure, power switch 230 to electrically un-couple, such as disconnect, the second EV 130b from the power source 235. For example, the processing device 210 can operate, or otherwise instruct, power switch 230 to switch to an open position. In certain embodiments, in response to the charging event for the second EV 130b being terminated, the processing device 210 proceeds to charge the first EV 130a according to the single charge operation in block 406. In certain embodiments, in response to the charging event for the second EV 130b being terminated, the processing device 210 proceeds to charge the first EV 130a while periodically, such as at each charging duration interval or at a new charging duration interval, providing a continuing maintenance charging power to the second EV 130b.

The processing device 210 repeats one or more of the aforementioned steps until batteries for each EV have attained the specified charge limits. For example, the processing device 210 can repeat blocks 422 through 438 until batteries for both the first EV 130a and the second EV 130b have achieved the specified charge limit. Thereafter, the processing device 210 can utilize one or more of the aforementioned steps to provide a charging power to each EV 130 to maintain the battery at a charge limit within 5% of the specified charge limit.

FIGS. 5, 6, 7 and 8 illustrate example structures for a multi-port charging unit according to this disclosure. The embodiments of the multi-port charging unit 145 shown in FIGS. 5, 6, 7 and 8 are for illustration only. Other embodiments could be used without departing from the scope of the present disclosure.

The multi-port charging unit 145 includes a housing 505 configured to enclose the processing components, such as the processing device 210, at least one storage device 215, at least one communications unit 220, at least one input/output (I/O) unit 225, at least one power switch 230 and converter 250 illustrated in FIG. 2. The housing 505 also includes a via to enable connection to the power source 235 as well as one or more vias 605 for the charging cable 240 and one or more vias for the charging port 245. The housing 500 also includes one or more slots or grooves 705 dimensioned to accommodate or hold the charging cable 240, the removable conductor, or both. The housing 505 includes a removable cover 805 configured to enable an operator to install or replace one or more components in the multi-port charging unit 145. In certain embodiments, the housing 505 includes an internal cover 810 configured to separate the housing into an adapter portion and a processing circuitry portion. The adapter portion is configured to house one or more adapters 815 while the processing circuitry portion is configured to house the processing device 210, at least one storage device 215, at least one communications unit 220, at least one input/output (I/O) unit 225, at least one power switch 230 and converter 250 illustrated in FIG. 2. For example, the removable cover 805 provides internal access to install or remove the one or more adapters 815 configured to connect the removable conductor. The housing 505 is configured to detachably mounted to a wall or structure via a mounting bracket 820. That is, the mounting bracket 820 can be affixed to the wall by a fastening means, such as screws, bolts, welds, or adhesives, the housing 505 can detachably couple to the mounting bracket 820.

Accordingly, embodiments of the present disclosure illustrate a multi-port charging unit is capable of charging at least two EVs. The multi-port charging unit is configured to utilize a power supply configured to provide charging power to one EV. That is, by alternating charging power between the at least two EVs, the multi-port charging unit is configured to draw power equivalent to charging a single EV. For example, by alternating charging power between the at least two EVs, the multi-port charging unit draws no more power, at any instant time, than is necessary to charge a single EV.

Although various features have been shown in the figures and described above, various changes may be made to the figures. For example, the size, shape, arrangement, and layout of components shown in FIGS. 1 through 3 and 6 through 8 are for illustration only. Each component could have any suitable size, shape, and dimensions, and multiple components could have any suitable arrangement and layout. Also, various components in FIGS. 1 through 3 and 6 through 8 could be combined, further subdivided, or omitted and additional components could be added according to particular needs. Further, each component in a device or system could be implemented using any suitable structure(s) for performing the described function(s). In addition, while FIG. 4 illustrates various series of steps, various steps in FIG. 4 could overlap, occur in parallel, occur multiple times, or occur in a different order.

To aid the Patent Office and any readers of any patent issued on this application in interpreting the claims appended hereto, applicants wish to note that they do not intend any of the appended claims or claim elements to invoke 35 U.S.C. §112(f) unless the words “means for” or “step for” are explicitly used in the particular claim. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. §112(f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus comprising:
a first power terminal configured to couple to a first electric vehicle (EV);
a second power terminal configured to couple to a second EV;
processing circuitry configured to selectively provide a charging power to the first EV and to the second EV by repeatedly alternately coupling a power source to the first power terminal and the second power terminal.

2. The apparatus of claim 1, wherein the processing circuitry is configured to:
during a first time period, electrically couple the power source to the first power terminal and electrically uncouple the second power terminal;
during a second time period, electrically couple the power source to the second power terminal and electrically uncouple the first power terminal; and
during a third time period, electrically couple the power source to the first power terminal and electrically uncouple the second power terminal.

3. The apparatus of claim 2, wherein the processing circuitry is configured to set a time duration for each of the first time period, second time period and third time period according to a charging duration.

4. The apparatus of claim 3, wherein the charging duration is one of:
pre-specified;
adjustable; or
calculated by the processing circuitry.

5. The apparatus of claim 3, wherein the charging duration is ten seconds.

6. The apparatus of claim 1, wherein the processing circuitry is configured repeatedly alternate coupling the power source to the first power terminal and second power terminal until the processing circuitry determines that a charge limit for a battery in the first EV or a battery in the second EV has been achieved.

7. The apparatus of claim 1, wherein the second power terminal comprises a charging port configured to removably couple to a charging cable, the charging cable comprising a first terminal adapted to removably couple to the charging port and a second terminal adapted to removably couple to the second EV.

8. A multi-port charging unit comprising:
a power cable configured to couple to a first electric vehicle (EV);
an expansion port configured to couple via a removable conductor to a second EV;
a switch configured to selectively couple a power source to the power cable and the expansion port; and
a processor configured to operate the switch to repeatedly alternate providing a charging power to the first EV and to the second EV.

9. The multi-port charging unit of claim 8, wherein the processor is configured to:
during a first time period, cause the switch to electrically couple the power source to the power cable and electrically uncouple the expansion port;
during a second time period, cause the switch to electrically couple the power source to the expansion port and electrically uncouple the power cable; and
during a third time period, cause the switch to electrically couple the power source to the power cable and electrically uncouple the expansion port.

10. The multi-port charging unit of claim 9, wherein the processor is configured to set a time duration for each of the first time period, second time period and third time period according to a charging duration.

11. The multi-port charging unit of claim 10, wherein the charging duration is one of:
pre-specified;
adjustable; or
calculated by the processing circuitry.

12. The multi-port charging unit of claim 10, wherein the charging duration is ten seconds.

13. The multi-port charging unit of claim 8, wherein the processor is configured repeatedly operate the switch to alternate coupling the power source to the first power terminal and second power terminal until the processor determines that a charge limit for a battery in the first EV or a battery in the second EV has been achieved.

14. The multi-port charging unit of claim 8, wherein the processor is configured to determine whether to perform a single EV charge operation or a multi-EV charge operation as a function of how many EVs are coupled to the multi-port charging unit.

15. A method comprising:
detecting a coupling of a first electric vehicle (EV) to be electrically charged;
determining that a second EV is coupled to be electrically charged;
repeatedly alternating a charging power to the first EV and to the second EV when the second EV is coupled to be electrically charged.

16. The method of claim 15, wherein alternating the charging power comprises:
during a first time period, electrically coupling a power source to the first EV and electrically uncoupling the second EV from the power source;
during a second time period, electrically coupling the power source to the second EV and electrically uncoupling the first EV from the power source; and
during a third time period, electrically coupling the power source to the first EV and electrically uncoupling the second EV from the power source.

17. The method of claim 16, further comprising setting a time duration for each of the first time period, second time period and third time period according to a charging duration.

18. The method of claim 17, wherein the charging duration is ten seconds.

19. The method of claim 15, further comprising repeatedly alternating coupling the power source to the first power terminal and second power terminal until a charge limit for a battery in the first EV or a battery in the second EV has been achieved.

20. The apparatus of claim 1, further comprising communicating charging information between at least one of the first EV or the second EV to determine parameters for charging at least one of the first EV or the second EV.
